(19) United States
(12) Patent Application Publication
(10) Pub. No.: US 2004/0144447 A1
(43) Pub. Date: Jul. 29, 2004

(54) Veneer-slicing machine

(76) Inventors: Jean Meyer, Friedewald (DE); Heinrich Webbler, Ludwigsau (DE); Armin Heiner, Hohenroda (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/477,973

(22) PCT Filed: Mar. 12, 2002
(86) PCT No.: PCT/EP02/02681

(30) Foreign Application Priority Data
May 16, 2001 (DE) 101 24 065.1

(51) Int. Cl. B27C 1/00; B27L 5/02

(52) U.S. Cl. 144/178

(57) ABSTRACT

In prior art veneer-slicing machines, the blade is always mounted so that its cutting edge is parallel to the plane of the table, inside of which a wooden beam can be clamped. As a result, it is not possible or only possible with a high degree of complexity, to make adaptations to the shape of the wooden beam, said shape being, for example, conical in some types of wood, or to the course of the grain in order to achieve an optimal sectional image and thus the best possible veneer quality. The inventive veneer-slicing machine should make it possible to make simple adaptations to the shape of the wooden beam or should be able to influence the sectional image. To this end, the tool slide (1) can be placed at an angle (α) that is slanted with regard to the plane of the table (17). This is achieved by the provision of at least one articulated connection that is placed between the supporting structure (6) and the guide elements (5), which are mounted on rails (3) in a manner that permits them to move back and forth.

The invention relates to a veneer-slicing machine according to the introductory clause of claim 1.

In a typical veneer-slicing machine, as for example known from EP 0,127,175, the table to which the flitch to be sliced is clamped moves up and down in a vertical plane. To this end the table is guided by means of guide rails and shoes. A slice of veneer is cut from the flitch, e.g. as it moves downward, by an upwardly directed blade. The blade is mounted together with a pressure plate on a tool support that is normally stationary during the cutting operation. For each cycle of the table movement the tool support is advanced toward the flitch through a distance equal to the thickness of the veneer slice. The cutting edge of the blade and also the face of the tool support turned toward the table are parallel to the plane of the table.

German 2,548,164 describes a veneer-slicing machine with a vertically or nearly vertically movable table that when used reciprocates vertically with a flitch clamped to it. A tool carriage with a blade and pressure plate as well as a conveyor belt for carrying off the veneer slices is movable at a right angle to the table. The cutting edge of the blade is directed downward. The cutting is done during upward movement of the table.

Veneer-slicing machines with different arrangements of the table and blade are also known but they have no widespread use.

With the known veneer-slicing machines the attack angle, that is the angle between the cutting edge of the blade and the plane of the table against which the flitch is clamped, is fixed at 0°; the table plane and the cutting edge thus are parallel. Thus it is only limitedly and at great difficulty possible to conform the attack angle for instance to tapered flitches or so as better to follow their shape. This leads to lower-quality veneers.

It is an object of the invention to provide a veneer-slicing machine that makes it relatively easy to conform the angle between the cutting plane and the clamping plane of a flitch and thus to substantially improve the quality of the veneer.

The object is attained by the charactering features of claim 1.

The means for setting the angle α between a plane of the table against which the flitch is clamped and the cutting edge of the angle ensures that veneers do not only have to be sliced off in a plane parallel to the table. Instead, the angle can be set in a practical range. Thus the cut can easily be conformed to various conditions so that at all times one can employ a cut plane optimized for veneer quality.

This ensures that even for example tree types with conical trunks can be used more for making veneer, or flitches whose grain runs differently than thought before rough-cutting of the piece can be optimally worked with respect to cut and veneer quality. This can be done without substantial investment of time or effort.

The dependent claims relate to preferred embodiments of the invention.

The size of the angle α from −10° to +10° ensures that the last bit of the flitch that cannot be cut into veneer is still a marketable size.

The invention is further described with reference to a simplified illustrated embodiment of a veneer-slicing machine with vertical table guides. Therein, schematically,

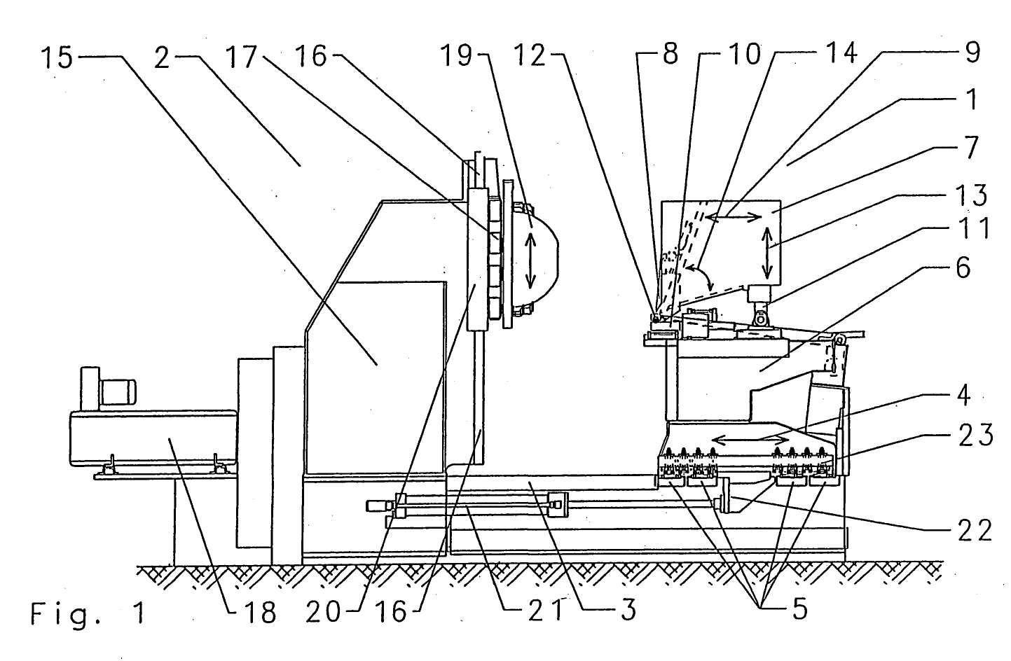

FIG. 1 is an end view of a veneer-slicing machine;

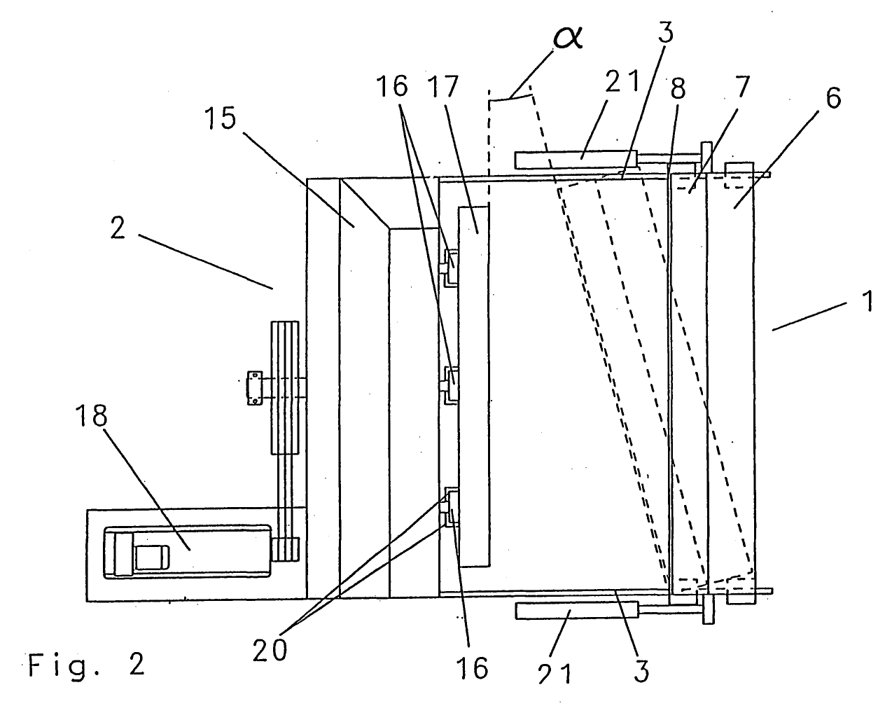

FIG. 2 is a view like FIG. 1 from above;

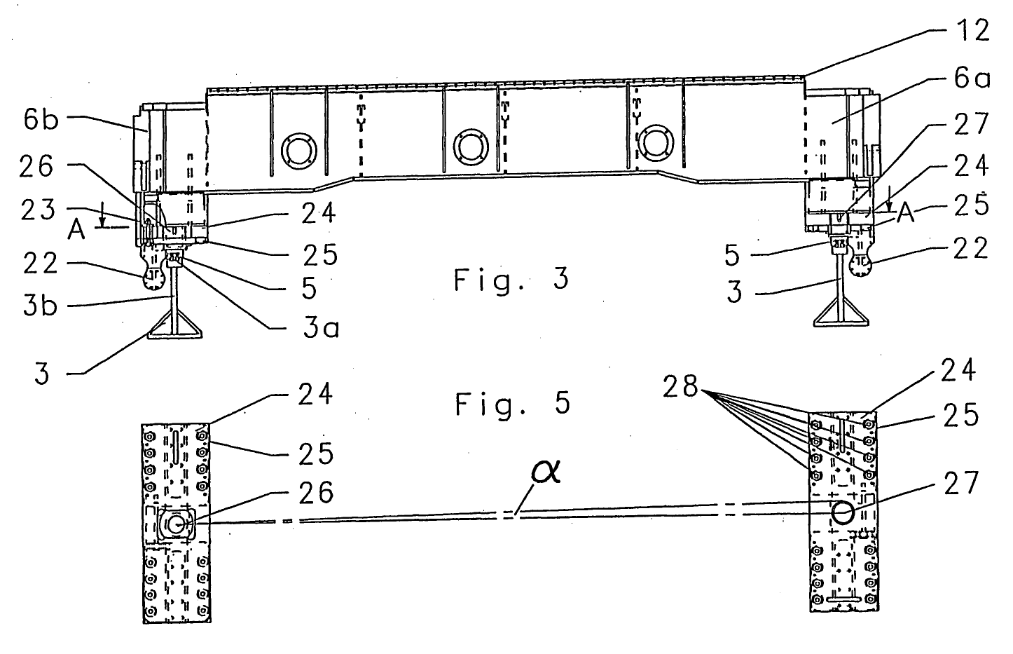

FIG. 3 is a view of a tool carriage without a blade holder seen from the side of table;

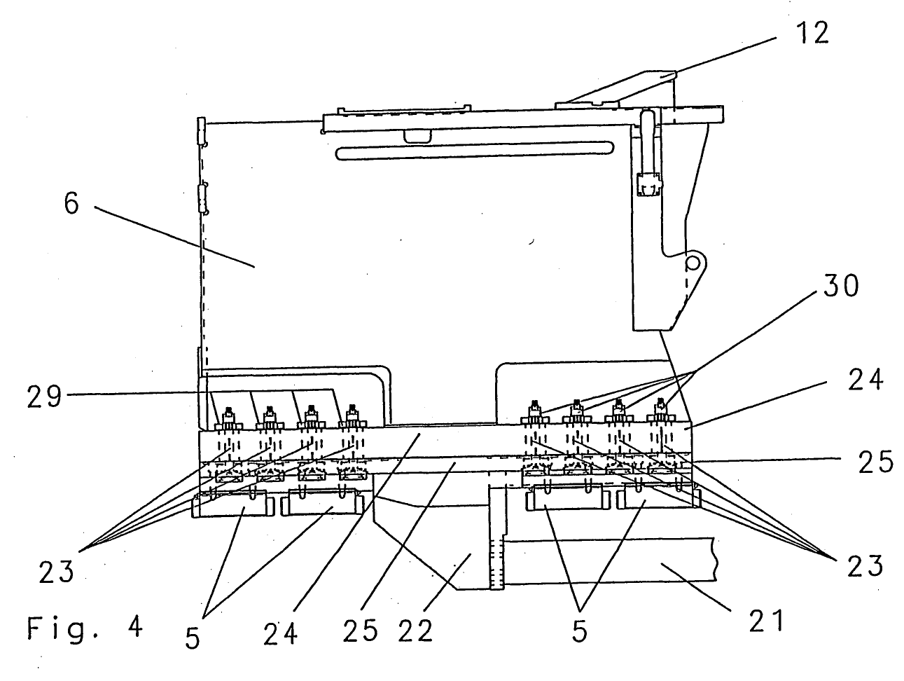

FIG. 4 is an enlarged view like FIG. 3 without rails; and

FIG. 5 is a section taken along line A-A of FIG. 3 from above.

As shown in FIG. 1 a slicing machine is basically formed by a tool carriage 1 and a table assembly 2.

The table assembly 2 is basically formed by a machine frame 15, guide rails 16 that are fixed to the machine frame 15, a table 17, and a drive motor 18. The table assembly 2 is fixed to the floor and positioned relative to the tool carriage 1 such that the cutting edge of the blade 8 is parallel to the table face to which a flitch 19 is clamped. The guide rails 16 are fixed on the machine frame 15. They each form with the vertical an acute angle, and their faces turned away from the machine frame 15 lie in a plane. The table 17 is secured by slide shoes 20 each formed by several parts on the guide rails 16 and is vertically reciprocal in a vertical plane along the guide rails 16. The flitch 19 is as is standard clamped by unillustrated hydraulic claws to the table 17.

The table 17 is movable on the guide rails 16 by means of the slide shoes 20. The slide shoes 20 are removably mounted on the table 17. Between each slide shoe 20 and the respective guide rail 16 are wear elements 23 that are also removable from the slide shoes so that the play between the slide shoes and the guide rails 16 can be adjusted. Here the play is set as small as possible so as to optimize the precision of the cut.

Two hydraulic cylinders 21 reciprocate the tool carriage 1 as shown by arrow 4 along two generally horizontal and parallel rails 3 that are fixed to the floor. Each rail is comprised of a guide rail 3a and a support structure 3b. Each hydraulic cylinder 21 is braced at one end on an abutment 22 of a frame 6 and at the opposite end on the rail 3. The tool carriage 1 is movable perpendicularly and with minimal play via guide elements 5 that are fixed on the frame 6 along the rails 3 so that during cutting of the flitch 19 into veneer it is only possible to move along the rails 3. The rails 3 and the guide elements 5 form a guide system.

An upper portion of the machine frame 6 carries a blade support 7 with a blade 8 that is vertically adjustable in the direction of arrow 9, and pivotal about a downwardly directed cutting edge of the blade 8. The blade 8 is mounted on a side of the blade carrier 7 that confronts the table assembly 2. The blade carrier 7 can be moved relative to the machine frame 6 as indicated by arrows 9, 13, and 14, as is necessary for adjusting its position with respect to a pressure plate 12 described below, by various hydraulic cylinders of which for clarity of view only two are shown at 10 and 11.

Below the blade 8 and parallel to it on the machine frame 6 is the pressure plate 12. The pressure plate 12 and blade 8 are set such that in use they are spaced slightly apart.

The machine frame 6 carries further unillustrated devices for carrying off a slice of veneer.

The above structure of the veneer-slicing machine corresponds to the state of the art.

As shown in FIG. 2 the tool carriage can be set at an acute angle α, which here is shown bigger than in practice for illustration purposes, relative to the table assembly 2, here relative to the vertical plane of the table 17. To this end the tool carriage 1 is pivotal about a vertical axis so as to form an acute angle between the vertical table plane and the (substantially horizontal) cutting edge of the blade 8 in a horizontal plane.

The means for setting the angle α is more closely described with reference to FIGS. 3 to 5.

Each longitudinal side 6a and 6b of the frame 6 is connected to the respective guide element on the respective rail by a pivot as follows:

A massive rectangular plate 24 is fixed against relative movement. e.g. by welding, underneath the right-hand end 6a of the frame 6. A face of the plate 24 is perpendicular to the adjacent side of the frame 6 and here is horizontal. The longitudinal axis of each plate 24 is directly above the longitudinal axis of the respective rail 3 when the cutting edge of the blade 8 is parallel to the table 17, that is when α=0°. A mainly round, throughgoing central, and perpendicular hole formed in the face of the plate 24 coaxially and rotatably receives a circular-section bolt 27 that is flush at its upper end with the face of the plate 24 but that projects downward from it. The bolt 27 is axially fixed in the hole. The face of the plate 24 is also formed near its longitudinal edges with four groups of four throughgoing bores 28.

Underneath each plate 24 is a second plate 25 that carries the upper plate 24. This second plate 25 has the same overall dimensions, a hole receiving the bolt 27, and the same bores 28 as the upper plate 24. The plates 24 and 25 abut at a plane and are congruently aligned when α=0°.

Each pair of aligned bores 28 of the plates 24 and 25 receives a respective piston of a hydraulic actuator 23, the diameters of the bores 28 being so large that there is play, e.g. of 15 mm, to the piston of the respective actuator 23.

Each actuator 23 is indirectly, e.g. via a further plate, or directly fixed to the lower plate 25. Each piston has a free end remote from the working cylinder of the respective actuator 23 and formed with a screwthread whose outside diameter is smaller than that of the piston. Each such screwthread is fitted with a stiff washer 29 that is secured by means of a nut 30 on the free end of the piston. The washer 29 has an outside diameter that is greater than the inside diameter of the respective bore 28 in the plate 24 so that each washer bears with the outer periphery of its lower face on the upper plate 24. The threaded end of the piston projects with some play through the central hole of the washer 29.

The actuators 23 can press the plates 24 and 25 together so that they form when clamped a rigid connection whereas when unclamped they permit relative shifting and/or pivoting of the plates 24 and 25.

The pivotal connection at the left end 6b of the frame 6 is identical to that on the right end 6a except that the hole in the upper plate 24 and the bolt 26 are different: The hole is formed as an elongated slot whose longitudinal axis is perpendicular to the longitudinal axis of the respective plate 24. The hole receives a disk 27a which is a snug fit to the longitudinal edges but which has several mm of play to the slot ends. A central hole of the plate 27a pivotally receives a bolt 27b.

In use except for setting the angle α between the table plane and the cutting edge of the blade, everything is the same as in the prior art, that is the tool carriage 1 is first set at the maximum possible spacing from the table 2, the so-called starting position. A flitch 19 is secured by the claws to the table 17 and the tool carriage 1 is set in the desired inclined position.

To this end all the actuators 23 are released, that is set to maximum length. One of the hydraulic cylinders 21 is moved in or out by the desired amount of for example ±100 mm (according to the angle α=0°). This shifts one end of the frame 6 along one of the rails 3, thereby pivoting the frame 6 on the bolts 26b and 27 and thus establishing the desired inclined position between the tool carriage and the clamping plane of the table 17. The bolt 26 permits some length compensation that is necessary along the connecting line between the bolts 26b and 27 as a result of the change in the angle α. Each angle α corresponds to a predetermined displacement that must be effected by inward or outward movement of the hydraulic cylinder 21 and is determined by the geometry of the tool carriage 1. As soon as it is set in the desired angle α, all the actuators 23 are pulled in and pressurized so that the plate 24 and 25 are solidly pressed together. In this manner the inclination at the angle α is fixed and the frame cannot move relative to the guide elements 5 so that the carriage 1 is precisely guided and the cuts will be exact.

The angle α is only adjusted when a change is needed.

It is preferable when the hydraulic cylinder 21 used to change inclination is the one remote from the bolt 26 which in addition to pivoting also shifts longitudinally.

The tool carriage 1 is now advanced by simultaneous extension of the two hydraulic cylinders into a working position that leaves a very small horizontal space between the flitch 17 and the cutting edge of the blade 8. The drive for the table 17 is turned on so as to vertically reciprocate the table 17. When it is up to speed and at a lower end position of the table 17, the tool carriage 1 is moved toward the flitch 19 such that during the next upward movement a slice of veneer of the desired thickness is cut off.

Once the table 17 reaches its upper end position, the tool carriage 1 is pulled back slightly so that the flitch 19 is not touched when moving back down. In the lower end position of the table 17 the tool carriage 1 is again indexed back through a distance equal to the desired thickness of the veneer from the previous position. This cycle is repeated until so many veneer slices have been cut from the flitch 17 that nothing but a minimal scrap of the flitch is left.

In order to get rid of the scrap of flitch 17, the tool carriage 1 is returned to the rest position. A new flitch 17 is clamped in place and the process is restarted.

During the entire operation except for setting the angle α the two hydraulic cylinders 21 are operated identically so that the tool carriage 1 moves parallel on the rails 3.

1. A veneer-slicing machine comprising
a reciprocal table to which a flitch is clampable, the table being slidable on guide rails; and
a tool slide carrying a pressure plate and a blade and reciprocal by hydraulic cylinders on a guide system along a line perpendicular to a movement plane of the table, characterized in that means are provided for setting an angle (a) between a plane of the table (17) to which the flitch (19) is clampable and the cutting edge of the blade (8).

2. The veneer-slicing machine according to claim 1, characterized in that the angle (a) is adjustable between −10° and +10°.

3. The veneer-slicing machine according to claim 1 or 2, characterized in that at least one pivot is provided between a frame (6) of the tool slide (1) and the guide system.

4. The veneer-slicing machine according to claim 3, characterized in that a lower plate (25) fixed on a guide element (5) of the guide system has a face carrying an upper plate (24) that is mounted on the frame (6) such that the plates (24 and 25) are relatively pivotal in a plane between the plates (24 and 25) so that the faces of the plates (24 and 25) are generally horizontal.

5. The veneer-slicing machine according to one of claims 1 to 4, characterized in that the adjustment of the angle (α) is effected by one of the hydraulic cylinders (21).

6. The veneer-slicing machine according to one of claims 1 to 5, characterized in that a plurality of clamping devices (23) are provided on the plates (24 and 25) that can press the upper plate (24) against the lower plate (25).
